(19) United States
(12) Patent Application Publication
(10) Pub. No.: US 2008/0254299 A1
(43) Pub. Date: Oct. 16, 2008

(54) Scratch-resistant Layered Composite and Articles

(75) Inventors: Sapna Blackburn, Mt. Vernon, IN (US); Kwan Hongladarom, Mt. Vernon, IN (US); Mike M. Laurin, Pittsfield, MA (US); Jan Pleun Lens, Breda (NL); Hendrik Theodorus van de Grampel, Mijnsheerenland (NL)

Correspondence Address: Marina Larson & Associates, LLC, P.O. BOX 4928, DILLON, CO, 80435, US

(73) Assignee: GENERAL ELECTRIC COMPANY, Schenectady, NY (US)

(21) Appl. No.: 11/734,994

(22) Filed: Apr. 13, 2007

(51) Int. Cl. B32B 23/08; C08G 65/48

(52) U.S. Cl. 428/412; 525/390

(57) ABSTRACT

Multi-layer composites having a blend of a dimethyl bisphenol cyclohexane polycarbonate and a bisphenol A polycarbonate as a top layer joined to a bisphenol-A polycarbonate second layer provide both surface scratch resistance and the ability to form molded and die cut articles. In the top layer, repeat units of dimethyl bisphenol cyclohexane are present in an amount of at least 50 weight percent relative of the total repeat units in the top layer, preferably in a weight ratio of from 60 to 75 weight percent.

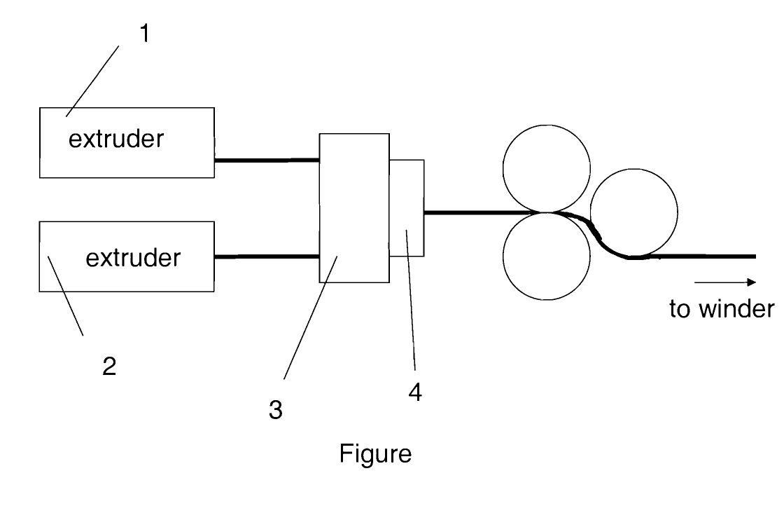

### BACKGROUND OF THE INVENTION

There is a need for thermoformable plastic films with good mechanical properties, good surface finish, high transparency, film processability and scratch resistance for in-mold decorating (IMD) applications for electronic components, cell phones, computer laptops and automotive bezels, etc. Film processability refers to film ability to be thermoformed into three-dimensional shape and then die-cut in specific locations to achieve a specific shape from the film without forming cracks. Film made from BPA-based polycarbonate resin is able meet these application requirements. However, this PC film is very easy to scratch.

One-way to achieve better resistance to scratching is to post-coat the three-dimensional thermoformed polycarbonate components with hard coat materials. This method adds extra post-production coating step and cost to the entire process. Another method is to pre-coat polycarbonate film with hard coat materials; the coating process is efficient since it is carried out before thermoforming on flit film. However, hard coat materials once cured are brittle and cannot be thermoformed or die cut effectively. Another route is to pie-coat polycarbonate film with hard coat materials but leave the coating uncured. This allows the film to be thermoformable and die-cut able. The drawback of this method is the extra steps involved in prevention of pre-mature curing of light sensitive uncured coating and handling vulnerability of the soft and easily damaged uncured coated film. Special packaging and outfitting the film processing area with special lights is used to prevent pre-mature curing.

This application relates to a scratch-resistant composite material, and to articles made using such a material. In the layered composites and articles of the invention, the outer layer is a polycarbonate comprising a blend of a dimethyl bisphenol cyclohexane polycarbonate (DMBPC-PC) and a bisphenol A polycarbonate (BPA-PC).

DMBPC is a dihydroxy monomer having the formula:

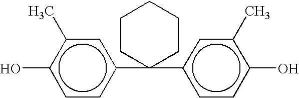

Polymerization of this monomer into a polycarbonate is known in the art, for example from US Patent Publication No. 2007/0009741 published Jan. 11, 2007 which is incorporated herein by reference in its entirety. In this publication, the use of DMBPC/BPA copolymers as scratch resistant coatings for polycarbonate articles is disclosed.

### SUMMARY OF THE INVENTION

The present invention provides composites comprising:

(a) a top layer comprising a blend of
a first polycarbonate comprising repeat units of dimethyl bisphenol cyclohexane, and
a second polycarbonate comprising repeat units of bisphenol A, said second polycarbonate being different from said first polycarbonate, wherein the repeat units of dimethyl bisphenol cyclohexane are present in an amount of at least 50 weight percent relative of the total repeat units in the top layer, preferably in a weight ratio of from 60 to 75 weight percent, and

(b) a second layer comprising a bisphenol-A polycarbonate, said second layer being joined with and in some embodiments directly adjacent to the top layer.

In specific embodiments, the first polycarbonate is a DMBPC homopolymer. In specific embodiment, the second polycarbonate is a BPA homopolymer. In specific embodiments, the first polycarbonate is DMBPC homopolymer and the second polycarbonate is BPA homopolymer.

The invention provides molded articles formed from the composite of the invention. In these applications, the composite provides the surface scratch resistance of the DMBPC-PC plus the impact resistant normally associated with polycarbonates. Specific articles include cell phone covers, cell phone lens, computer cases and covers, particularly for lap tops, and automotive bezels.

### BRIEF DESCRIPTION OF THE DRAWING

The FIGURE shows a schematic of a calendaring co-extrusion process.

### DETAILED DESCRIPTION OF THE INVENTION

Definitions

In the specification and the claims which follow, reference will be made to a number of terms which shall be defined to have the following meanings:

The singular forms “a”, “an” and “the” include plural referents unless the context clearly dictates otherwise.

“Optional” or “optionally” means that the subsequently described event or circumstance may or may not occur, and that the description includes instances where the event occurs and instances where it does not.

“Polycarbonate”, unless described otherwise, refers to polycarbonates incorporating repeat units derived from at least one dihydroxy aromatic compound and includes copolyestercarbonates, for example a polycarbonate comprising repeat units derived from resorcinol, bisphenol A, and dodecandioic acid. Nothing in the description and claims of this application should be taken as limiting the polycarbonate to only one kind of dihydroxy repeat unit unless the context is expressly limiting. Thus, the application encompasses copolycarbonates with repeat units of 2, 3, 4, or more types of different dihydroxy compounds.

“Repeat unit(s)” means the units that are contained within the polymer chain of the polycarbonate and are derived from the starting dihydroxy compositions described below.

The articles of the present invention may be transparent, translucent, or opaque depending on the application.

“Transparent” is understood to mean that the sheet or article has light transmission of 50%, preferably 70%, and most preferably greater than 80% and a haze of less than 7, preferably less than 5, more preferably less than 2. Further, the term “transparent” does not require that all of the sheet or article is transparent and portions of the sheet or article may be opaque or translucent, for example to form a decorative pattern. All light transmission and haze values referred to herein are measured by ASTM D1003 at a thickness of 4.0 millimeters.

“Translucent” is herein defined as having a light transmission of about 25 to about 95% and haze less than 104% and greater than 7%.

“Coating” is a substance placed on the inner and/or outer surfaces of the sheet or an article of the present invention. Typical coatings are anti-static coatings, UV protection coating, Easy Clean® coatings, anti-microbial coatings, infra red shielding coatings, and hard coats. Typical hard coats can be silicone hard coats, acrylate hard coats (UV or thermally curable), silicone hard coats with acrylate primers, polyurethane hard coats, and melamine hard coats. Silicone hard coats are often preferred.

“Coplanar” as used in the present invention is not meant to indicate that the articles of present invention are necessarily flat or defined solely in single plane. The term as used herein means that the identified “coplanar” layer has the same relative shape as the underlying or overlying layer that it is referenced to. For example, the articles of the present invention may be curved.

Composites of the Invention

The present invention provides composites that comprise at least two polymeric layers, referred to herein as a top layer and a second layer. Additional polymeric layers may also be present without departing from the invention. However, as the term “top layer” implies, this layer is the outermost layer on one surface of the composite during molding, although it may be covered with a coating after molding of the composite into an article.

The multi-layer composite of the invention is suitably formed using a continuous calendaring co-extrusion process as shown schematically in the FIGURE. In this process, extruders 1 and 2 supply the molten resin for the individual layers (i.e. the top layer, the second layer and any additional polymeric layers) into a feed block 3. A die 4 forms a molten polymeric web that is feed to a set of calendaring rolls 5. Typically, there are 2 to 4 counter-rotating cylindrical rolls made from steel or rubber coated steel. The rolls may be heated or cooled. The molten web formed by the die is successively squeezed between these rolls. The inter-roll clearances or “nips” through which the webs is drawn determines the thickness of the layers. The multi-layer composite of the invention may also be formed from separate preformed films corresponding to the polymeric layers which are subsequently laminated together, for example using heated rolls and optionally adhesive tie layers.

The thickness of the composite of the invention is determined by the application and the equipment used in forming the composite. For many applications, the thickness of the material will range from 0.001 inches to 0.5 inches (25 micrometers to 12.7 mm), for example 0.002 to 0.030 inches (50 to 750 micrometers). Overall thickness of 0.007 to 0.30 inches (175 micrometers to 7.62 mm) are preferred for some applications.

The top layer in the composites of the invention comprises a blend of a first polycarbonate comprising repeat units of dimethyl bisphenol cyclohexane; and a second polycarbonate comprising repeat units of bisphenol A. The second polycarbonate is different from said first polycarbonate. In the top layer, the repeat units of dimethyl bisphenol cyclohexane are present in an amount of at least 50 weight percent relative of the total repeat units in the top layer, preferably in a weight ratio of from 60 to 75 weight percent.

This composition of the top layer is different from the copolymer layers which are described in the examples of US Patent Publication No. 2007/0009741. As will be understood in the art, random copolymers tend to adopt one set of properties which is somewhere between the properties of homopolymers of the individual polymers. In blends on the other hand, each polymer type retains its own original properties and these interact in different ways to form the final properties of the blend. Furthermore, blends may encounter issues with miscibility and compatability of the polymers that is not an issue in a homogenous copolymer.

In US 2007/0009741, results are provided for DMBPC-PC/BPA-PC blends and for a top layer of a DMBPC-PC homopolymer. formulated with a UV stabilizer. The scratch resistance of these materials was found to be good. However, it was subsequently determined that particularly in the case of the homopolymer top layer, the impact strength and the ability to form and trim molded articles from this material was poor. The present invention in which blends are used in the top layers addresses this issue, while generally maintaining the same level of performance as the copolymer in other relevant respects such as scratch resistance.

In one specific embodiment of the invention, the first polycarbonate in the top layer is a DMBPC homopolymer. Suitable DMBPC homopolymers have molecular weights in the range of 18,000 to 35,000, preferably 20,000 to 30,000 and more preferably from 20,000 to 25,000 as determined by GPC with PC standards. The polymers have Tg values in the range of 135 to 145° C., that are comparable to that of BPA homopolymer, and therefore that can be easily used in the coextrusion process.

In another specific embodiment, the second polycarbonate in the top layer is a BPA homopolymer. Suitable BPA homopolymers have molecular weights in the range of 20,000 to 35,000, preferably 21,000 to 31,000 and more preferably from 25,000 to 31,000 (polycarbonate standards)

In yet a further specific embodiment, the first polycarbonate in the top layer is DMBPC homopolymer and the second polycarbonate in the top layer is BPA homopolymer, each as described above.

The top layer has sufficient thickness to provide the level of scratch resistance required for the application. The top layer may be from 10% to 99% of the total thickness of the composite, for example 10 to 50%, more preferably 20 to 40% and most preferably 20 to 35%. Thus, the top layer may be from 0.0001 to nearly 0.5 inches thick (2.5 micrometers to 12.7 mm), but will more commonly be in the range of from 0.0007 to 0.029 inches (1.78 micrometers to 0.74 mm). Increasing the thickness of the cap layer as a % of the total thickness, has an affect on the measured pencil hardness. For example, for a cap layer with 50% DMBPC, the pencil hardness (1000 g) of a 10 mil (0.254 mm) total thickness film varies as follows: 10%-F, 20%-F; 30%-H, 50%-H. For higher levels of DMBPC in the cap layer, the hardness achieved at greater thickness could be higher, for example 2H or 3H.

The second layer of the invention is a polymer layer comprising repeat units of bisphenol A. This layer may be transparent, translucent or opaque, depending on the application, and may contain metal flakes, fillers, colorant and the like to impart a desired visual appearance to articles made from the composite.

In some embodiments of the invention, the second layer is a BPA homopolymer, which may the same as or different from any BPA-homopolymer used in forming the blend for the top layer). In another specific embodiment, the second polycarbonate is a BPA homopolymer. Suitable BPA homopolymers have molecular weights in the ranges set forth above for the materials in the top layer. The polymer of the second layer may be copolymer or a blend with additional repeat units selected to achieve properties suited for a given application.

In some embodiments, as reflected below in the examples, the composite of the invention may consist of just the top layer and the second layer. In other cases, additional layers may be included. Such additional layers can be divided into two groups: additional layers between the top layer and the second layer, and additional layers on the side of the second layer opposite the top layer.

If there are no additional layers between the top layer and the second layer, the two layers are referred to herein as being joined and directly adjacent. If there is an additional layer between the top layer and the second layer, the two layers are still joined (via the additional layer(s)), but they are no longer directly adjacent. Additional layers used between the top layer and the second layer may serve as tie layers (should compatiblization be necessary between the top layer and the second layer) or may be used to create decorative effects.

Additional layers disposed on the side of the second layer opposite the top layer may be of any type desirable based on the intended application of the composite. There may include fiber-reinforced substrates, decorative layers such as inks, metallization or hot stamping, or tie layers to aid in compatability with a molded, extruded, laminated or otherwise bonded layer. In one specific embodiment, an additional layer in this position has the same composition as the top layer, to provide scratch resistance on both surfaces of a molded article.

### Method of the Invention

The present invention also provides a method of making a molded article comprising the steps of forming a composite in accordance with the invention into a desired shape for the article, and cutting the formed article to form desired openings in the article. This formed article suitably serves as an insert in a mold, which is then molded behind with resin in a conventional manner to form a final molded article.

In the method of the invention, the step of forming the composite into a desired shape may be done using any forming processes including without limitation thermoforming, pressure forming, pressure assist thermoforming, hydro forming, embossing, match die forming, zero gravity forming, plug assist forming, and snap back forming.

In the method of the invention, the step of cutting the formed article can be done by any suitable cutting technique for the thickness of the material, including without limitation stamping, die cutting, match die cutting, steel rule die cutting, laser cutting, routering, and water jet cutting.

In the method of the invention, the step of molding behind can be done using any conventional molding technique, including without limitation injection molding, foam molding, gas assist injection molding, blow molding, injection compression molding, and compression molding. Suitable process and materials are known, for example from U.S. Pat. Nos. 6,458,913, 6,465,102 and 6,548,005 which are incorporated herein by reference.

As is apparent from the discussion of the composites above, decorative features in the molded articles may be incorporated into the composite prior to forming. They may also be added during the molding behind step, or after molding. The article may also be hard-coated with a top coat after the molding behind step.

The invention will now be further described with reference to the following non-limiting examples.

### EXAMPLES A-E

Co-extruded film articles comprising of a top layer containing various amounts of DMBPC-PC and bisphenol A polycarbonate substrate were made using the calendering process. Commercial grade Lexan® ML9735 was used for the substrate. The DMBPC-PC used in the compositions was made by a melt process and had the following properties;

| | |
|---|---|
| MW | 25,000 (PC standards) |
| MFR | 8 g/10 min |
| Tg | 137° C. |

The BPA-PC used was LEXAN® 101 which has the following properties:

| | |
|---|---|
| MW | 30,500 (PC standards) |
| MFR | 7 g/10 min |
| Tg | 144° C. |

The two layer composite formed had an overall thickness of about 10 mil (250 micrometers), of which the top layer was about 20% i.e. about 2 mil (50 micrometers).

The film samples were tested for scratch resistance via pencil hardness test (ASTM D3363), abrasion resistance via tabor abrasion test at 50 cycle (ASTM D1044) and impact performance via multi-axial impact test (ASTM D3763). The sides with DMBPC-PC containing cap layers were the sides impacted. The film samples were also thermoformed using a cellular phone cover male forming tool. The thermoformed films were then trimmed to desired geometry on a matched die-trimming tool. Visual evaluations were made on the thermoformed and die-cut parts; judging for part definition, appearance and occurrences of surface defects such as wrinkles from thermoforming and surface cracks from trimming process.

The formulations tested and the results from the tests are tabulated in Table 1.

TABLE 1

| | Examples | | | | |
|---|---|---|---|---|---|
| | A | B | C | D | E |
| Description | PC Film | DMBPC cap | DMBPC cap | DMBPC cap | DMBPC cap |
| | | PC Film | PC Film | PC Film | PC Film |
| wt % DMBPC-PC in | 0% | 50% | 62% | 73% | 85% |
| Cap Layer | | | | | |
| Substrate Layer | Lexan ® ML9735 | Lexan ® ML9735 | Lexan ® ML9735 | Lexan ® ML9735 | Lexan ® ML9735 |
| Pencil Hardness | 6B | F | H | 2H | 3H |
| Tabor Abrasion (del | 24.8 | 20.7 | 19.0 | 18.5 | 15.7 |
| haze/50 cycles) | | | | | |
| Multi-axial Impact | 4.9 | 4.2 | 4.5 | 2.50 | 0.30 |
| (Total Energy J) | | | | | |
| Forming Capability | Good* | Good* | Good* | Good* | Good* |
| Trimming Capability | Good* | Good* | Good* | Good* | Poor* |

*
*Good (good definition and no cracks during forming, no cracks during trimming)
*Poor (cracks along line of impact from match die tool)

Table 1 shows increasing pencil hardness as percentage of DMBPC-PC in the cap layer increases. It will be appreciated that pencil hardness is a measurement that is subject to variations dependent on the test taker, and that these results should be considered as comparative, within this data set but not necessarily as absolute. Even at 50 wt. % DMBPC-PC (Example B) the pencil hardness of F is substantially higher than those tested for polycarbonate film at 6B (Example A). At 85 wt. % DMBPC-PC (Example E) the hardness is rated at an excellent 3H. The examples also showed similar abrasion resistance improvement with increasing DMBPC content. At 50% DMBPC content (Example B) abrasion resistance as measured by delta haze after exposure to tabor wheel for 50 cycles showed 16.5% improvement over Example A. At 62 wt % DMBPC-PC content (Example C) the improvement is 23.4% and at 85 wt % DMBPC-PC (Example E) the improvement is 36.7% over polycarbonate. The impact performance is observed to decrease with the increasing DMBPC-PC content. The largest impact drop is observed at 85 wt % DMBPC-PC (Example E) which only retains 5.9% of the impact of Example A, a 100% polycarbonate film. The smallest impact drop is observed for 62 wt % DMBPC-PC (Example C) which retained 91.8% of the impact performance of Example A. At 50 wt % DMBPC-PC (Example B) the impact retention is observed to be 79.6%.

The forming capabilities are judged to be good for all DMBPC-PC contents evaluated, however at 85 wt % DMBPC-PC content (Example E), the ability to trim the part using match die tool is unacceptable with cracks observed along the impact lines when the parts are punched out of the die tool.

It is thus observed that by using DMBPC-PC/BPA-PC blend for the top layer on a polycarbonate co-extruded calendered films substantial improvement of scratch and abrasion resistance can be obtained. By keeping the DMBPC-PC level below that of 85 wt % and preferably from 50 wt % to 75 wt %; we are able to produce co-extruded films that can be thermoformed and trimmed. Some impact drops are observed with introduction of DMBPC-PC into the cap layer, with the amount of 62 wt % DMBPC-PC content (Example C) showing the least reduction at 8.2% impact drop from all polycarbonate film (Example A).

1. A composite comprising:
(a) a top layer comprising a blend of
a first polycarbonate comprising repeat units of dimethyl bisphenol cyclohexane; and
a second polycarbonate comprising repeat units of bisphenol A, said second polycarbonate being different from said first polycarbonate, wherein the repeat units of dimethyl bisphenol cyclohexane are present in an amount of at least 50 weight percent relative of the total repeat units in the top layer;
(b) a second layer comprising a bisphenol-A polycarbonate, said second layer being joined with the top layer.

2. The composite of claim 1, wherein the repeat units of dimethyl bisphenol cyclohexane are present in an amount of from 60 to 75 weight percent relative of the total repeat units in the top layer.

3. The composite of claim 1, wherein the first polycarbonate is dimethyl bisphenol cyclohexane homopolymer.

4. The composite of claim 3, wherein the repeat units of dimethyl bisphenol cyclohexane are present in an amount of from 60 to 75 weight percent relative of the total repeat units in the top layer.

5. The composite of claim 1, wherein the second layer is directly adjacent to the top layer.

6. The composite of claim 5, wherein the repeat units of dimethyl bisphenol cyclohexane are present in an amount of from 60 to 75 weight percent relative of the total repeat units in the top layer.

7. The composite of claim 6, wherein the first polycarbonate is dimethyl bisphenol cyclohexane homopolymer.

8. The composite of claim 7, wherein the repeat units of dimethyl bisphenol cyclohexane are present in an amount of from 60 to 75 weight percent relative of the total repeat units in the top layer.

9. The composite of claim 1, wherein the second polycarbonate a bisphenol-A homopolymer.

10. The composite of claim 9, wherein the repeat units of dimethyl bisphenol cyclohexane are present in an amount of from 60 to 75 weight percent relative of the total repeat units in the top layer.

11. The composite of claim 9, wherein the first polycarbonate is dimethyl bisphenol cyclohexane homopolymer.

12. The composite of claim 11, wherein the repeat units of dimethyl bisphenol cyclohexane are present in an amount of from 60 to 75 weight percent relative of the total repeat units in the top layer.

13. The composite of claim 9, wherein the second layer is directly adjacent to the top layer.

14. The composite of claim 13, wherein the repeat units of dimethyl bisphenol cyclohexane are present in an amount of from 60 to 75 weight percent relative of the total repeat units in the top layer.

15. The composite of claim 14, wherein the first polycarbonate is dimethyl bisphenol cyclohexane homopolymer.

16. The composite of claim 15, wherein the repeat units of dimethyl bisphenol cyclohexane are present in an amount of from 60 to 75 weight percent relative of the total repeat units in the top layer.

17. A method of making a molded article comprising the steps of forming a composite into a desired shape for the article, and cutting the formed article to form desired openings in the article, wherein the composite comprises:
(a) a top layer comprising
a blend of a first polycarbonate comprising repeat units of dimethyl bisphenol cyclohexane; and
a second polycarbonate comprising repeat units of bisphenol A, said second polycarbonate being different from said first polycarbonate, wherein the repeat units of dimethyl bisphenol cyclohexane are present in an amount of at least 50 weight percent relative of the total repeat units in the top layer;
(b) a second layer comprising a bisphenol-A polycarbonate, said second layer being joined with the top layer.

18. The method of claim 17, wherein the repeat units of dimethyl bisphenol cyclohexane are present in an amount of from 60 to 75 weight percent relative of the total repeat units in the top layer.

19. The method of claim 18, wherein the first polycarbonate is dimethyl bisphenol cyclohexane homopolymer.

20. The method of claim 19, wherein the repeat units of dimethyl bisphenol cyclohexane are present in an amount of from 60 to 75 weight percent relative of the total repeat units in the top layer.

21. The method of claim 17, further comprising the step of molding behind the formed article after cutting with a resin to form a molded article.

22. A molded article prepared by the method of claim 21.
